(19) United States
(12) Patent Application Publication
(10) Pub. No.: US 2006/0021586 A1
(43) Pub. Date: Feb. 2, 2006

(54) Device for Handling Snakes

(75) Inventor: Judith Jezl, League City, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: ANIMAL CAPTURE EQUIPMENT, INC., Bacliff, TX (US)

(21) Appl. No.: 11/161,197

(22) Filed: Jul. 26, 2005

Related U.S. Application Data
(60) Provisional application No. 60/591,733, filed on Jul. 28, 2004.

(51) Int. Cl. A01K 15/04

(52) U.S. Cl. 119/801

(57) ABSTRACT

A lightweight snake hook includes a hook portion attached to a distal end of a shaft portion. The shaft portion can be a hollow rod of aluminum or fiberglass, and an end of the hook portion can be attached to the hollow end with an epoxy. The hook portion has a profile, such as U-shaped, “recurve,” S-shaped, or rectilinear, for supporting the snake. The hook portion is formed from a substantially cylindrical rod of polycarbonate bent into the profile. The polycarbonate hook portion is lightweight and strong and allows a handler to use the hook on long shafts and with large bodied snakes. Furthermore, the hook portion has a diameter providing a broad base or resting area for the snake. For example, the broad base is beneficial for snakes having delicate ribs, such as the Gaboon Viper.

### CROSS-REFERENCE TO RELATED APPLICATIONS

This application claims the benefit of U.S. Provisional Application Ser. No. 60/591,733 filed Jul. 28, 2004, which is incorporated herein by reference.

### FIELD OF THE INVENTION

The subject matter of the present disclosure generally relates to a device for handling snakes and more particularly relates to a strong, lightweight snake hook for handling large body snakes and venomous snakes.

### BACKGROUND OF THE INVENTION

Referring to FIGS. 1A-1B, a snake hook 10 according to the prior art is illustrated. The snake hook 10 includes a hook portion 12 and a shaft portion 14. The snake hook 10 is similar to hooks available from Midwest Tongs.com (http://www.tongs.com), (http://www.tomahawklivetraps.com), and Animal Care Equipment & Services, Inc. (http://www.animal-care.com). The hook portion 12 is made from a solid, aluminum rod, which is aircraft grade and may or may not be anodized. The hook portion 12 is inserted into the end 15 of the shaft, which is hollow. The diameter or thickness 16 of the hook portion 12 can be about 3/16-inch or ⅜-inch. For larger snake hooks, the jaw opening 18 of the hook can be about 3.5-inches wide at the end. For smaller hooks, for example, the jaw opening can be about 1.5-inches. The shaft portion 14 is made with stainless steel and may be a slightly flexible. The shaft can be from 16 to 24-inches long.

Some embodiments of snake hooks in the prior art include integral hook and shaft portions 10 and 12 that are made from 3/16-inch metal rod. One such integral snake hook is available from Tomahawk Live Trap (http://www.tomahawklivetrap.com) and is about 47-inches in length. Animal Care Equipment & Services, Inc. (http://www.animal-care.com) similarly has an integral rod snake hook that is about 4-ft. long and has a jaw opening of about 2-inches. The longer snake hooks with wider jaw openings are recommended for restraining and lifting large, heavy-bodied snakes, such as constrictors or pythons.

Referring to FIGS. 2A-2B, another snake hook 20 according to the prior art is illustrated. The snake hook 20 includes a hook portion 22 and a shaft portion 24. The snake hook 20 is similar to hooks available from Snakesticks.com, Inc. (www.snakesticks.com) of Miami, Fla. The snake hook 20 can be used for handling heavy-bodied venomous snakes. The hook portion 22 is made from stainless steel, although aluminum is also used. The hook portion 22 is flat and has a width 27 of about 1.25-inch and a thickness of about 3/16-inch. The hook portion 22 can have a jaw opening of about 2 to 3-inches. The shaft portion 22 is extendable and is made from fiberglass and aluminum shaft. The shaft portion 22 can be extended from about 31-inches to about 50-inches.

The larger snake hooks are used to handle large body snakes, such as Boa constrictors, pythons, etc. However, aluminum hook portions are not typically intended for supporting heavy-bodied snakes, and steel or titanium is used instead. When handling large snakes, handlers may use two larger snake hooks at the same time to pick up and move the snake. Because neonate or newborn snakes can still be venomous, use of a hook is still beneficial in handling these snakes. When used on neonates, however, the metal hooks known in the art can puncture the skin of the snake or can crush these snakes.

By way of example, boa constrictors in captivity can exceed a weight of 60 pounds but usually they will not exceed 30 pounds as adults. Boa constrictors can be a length of about 6 to 10-ft. Pythons, such as an Indian python, can be about 12-ft. in length. A typical adult Indian python weighs between 70-120 pounds. The Burmese variety of python tends to be longer and heavier.

One large body venomous snake is the Gaboon Viper, which lives on the rain forest floor in the equatorial belt of Tropical Africa. The Gaboon Viper is poisonous and deadly, and its venomous bite can kill a human within 15 minutes. Gaboon Vipers can reach an average length of 1.2 meters, but they have been found as long as 2.2 meters. These animals will weigh about 7 to 10 kg. The average size of an adult is about 4 to 5 feet, being the largest viper in Africa attaining weights of over 20 kg.

When handling a larger body venomous snake, the snake hook is preferably long. Furthermore, two snake hooks are preferably used. Therefore, it is important that the hook is strong but lightweight, because the snake may itself be heavy and the ability to lift and move the snake is made more difficult by the longer length of the snake hook. In addition, the Gaboon Viper has substantially delicate ribs, which can be separated by about ¼-inches. When the Viper rests on the thin hook, the underside of the snake's body folds in a V-shape over the hook. Because of the small area of the thin hook when the snake folds over the hook, the weight of the snake will cause the vertebrae or rib to break at the point it folds on the metal hook. Thus, using conventional snake hooks formed from thin rods or flat metal plates may harm the Gaboon Viper. Furthermore, a Gaboon Viper that rests uncomfortably on a thin metal hook of the prior art will be harder to handle as the snake attempts to remove itself onto the shaft portion, which is undesirable for the handler. Therefore, a need exists for a strong and lightweight snake hook that has a broader base can be used with large venomous snakes, such as the Gaboon Viper, without injuring the vertebrae or ribs of the snake. In addition, a need exists for a strong and lightweight snake hook that easier to handle and makes the lightweight hook more useful than the heavier metal counterparts explained above.

The subject matter of the present disclosure is directed to overcoming, or at least reducing the effects of, one or more of the problems set forth above.

### SUMMARY OF THE DISCLOSURE

A lightweight snake hook for handling a snake includes a shaft portion and a hook portion. The hook portion is attached to a distal end of the shaft portion. In one embodiment, for example, the shaft portion can be a hollow rod of aluminum or fiberglass, and an end of the hook portion can be attached to the hollow end with an epoxy. The hook portion has a profile for supporting the snake. The profile can be U-shaped or a “recurve,” S-shaped, or rectilinear. The hook portion is formed from a substantially cylindrical rod of polycarbonate bent into the profile. Preferably, solid Lexan® polycarbonate from GE is used. The substantially cylindrical rod of polycarbonate has a diameter of about 0.5 to 1-inch. The hook portion has a jaw opening of approximately 0.5 to 3.5-inches. The polycarbonate hook portion is lightweight and strong and allows a handler to use the hook on long shafts and with large bodied snakes without adding substantial weight. Furthermore, the hook portion has a diameter providing a broad base or resting area for the snake without adding substantial weight to the snake hook. The broad base is beneficial for snakes having delicate ribs, such as the Gaboon Viper.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIGS. 1A-1B illustrate a snake hook according to the prior art.

FIGS. 2A-2B illustrate another snake hook according to the prior art.

FIGS. 3A-3B illustrate an embodiment of a snake hook according to certain teachings of the present invention.

FIGS. 4A-4B illustrate various embodiments of the disclosed snake hook.

FIG. 5 shows a handler with the disclosed snake hook moving a python.

FIG. 6 shows a Gaboon Viper supported on the disclosed snake hook.

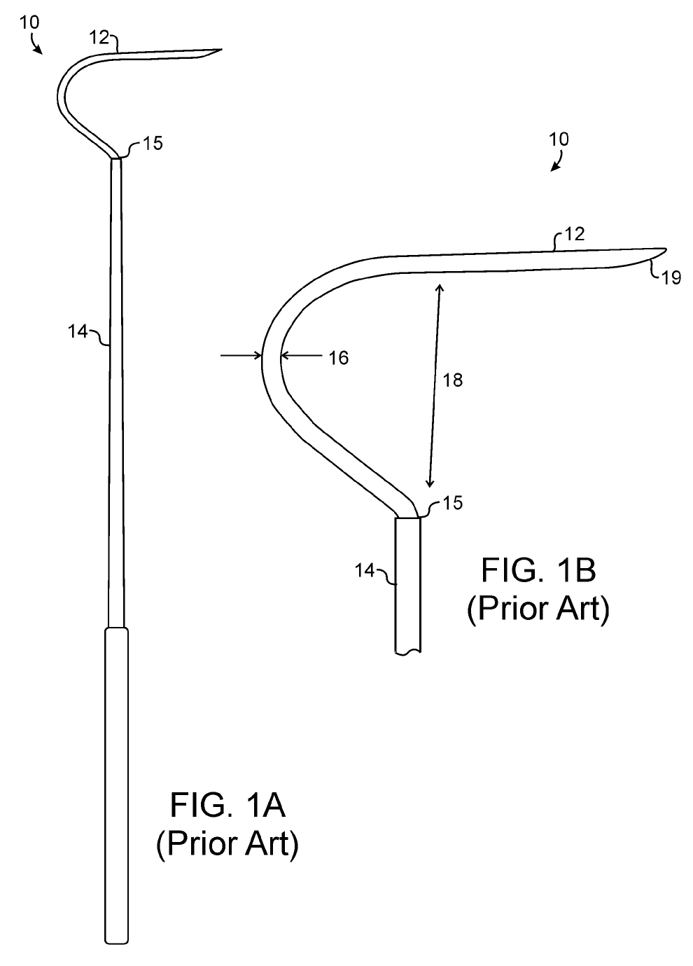

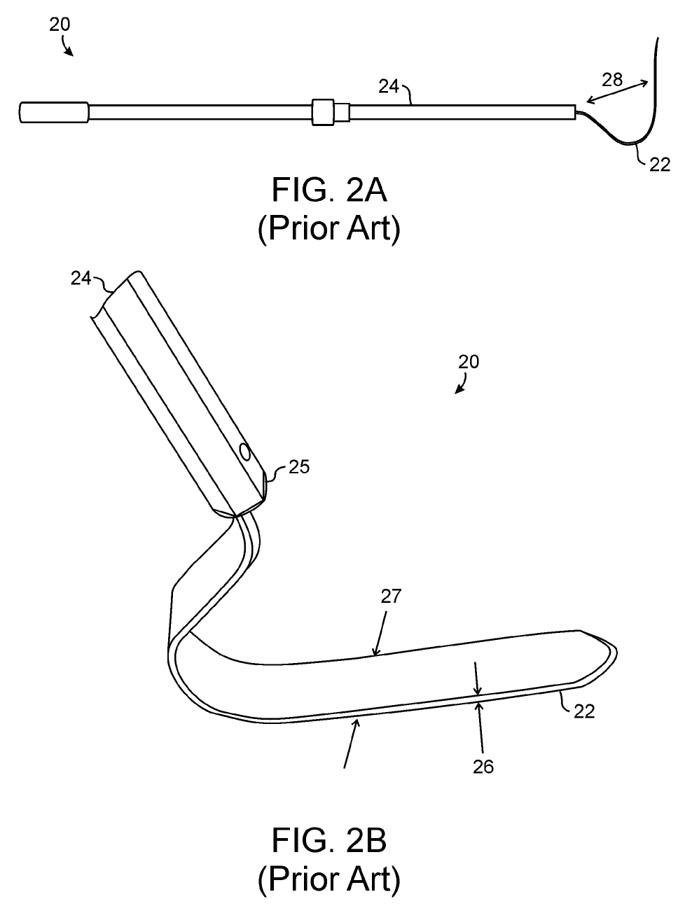

While the disclosed snake hook is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

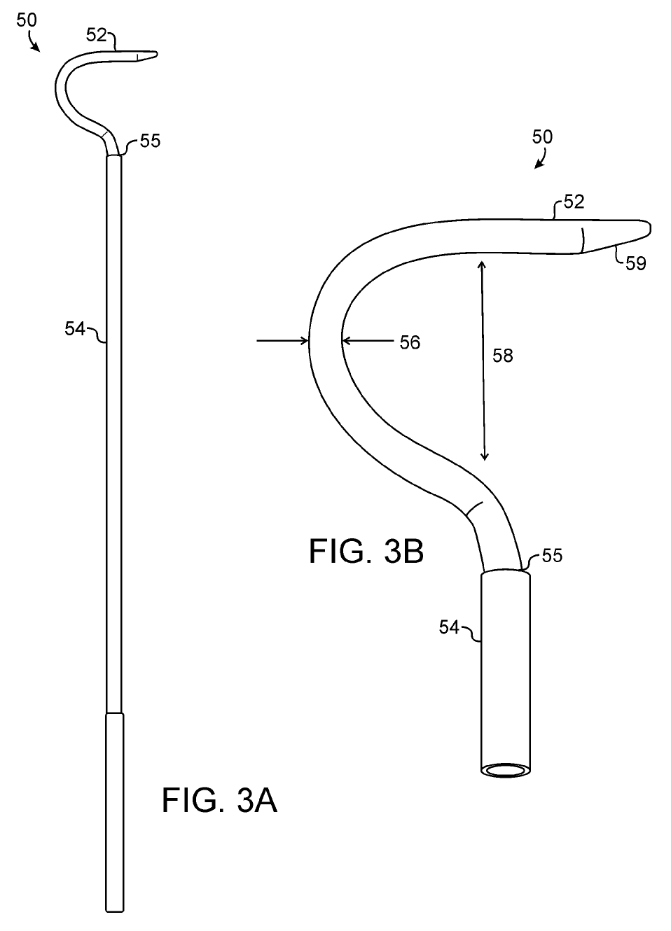

Referring to FIGS. 3A-3B, an embodiment of a snake hook 50 according to certain teachings of the present invention is illustrated. The snake hook 50 includes a hook portion 52 and a shaft portion 54. In the present embodiment, the hook portion 52 is formed into a profile having U-shape or “recurve.” Other profiles for the hook portion 52 include a V-shape or those disclosed below. The hook portion 52 is composed of a plastic material. Some plastic materials for the hook portion 52 can include thermoplastics, such as High-Density Polyethylene (HDPE) and Ultra High Molecular Weight Polyethylene (UHMW-PE), and can include acetal resins, such as Delrin®. These materials can be cast and machined to make the hook portion 52. Other plastic materials known in the art can be used and can be formed by casting, machining, molding, injection molding, and other techniques known in the art for forming the plastic material in to the hook portion 52.

Preferably, the hook portion 52 is composed of polycarbonate and more preferably solid, Lexan® polycarbonate. As is known, polycarbonate is a lightweight plastic used in a variety of industries. Preferably, the disclosed hook portion 52 is formed from a preformed rod of extruded polycarbonate. The rod is substantially cylindrical and can have a cylindrical, hexagonal, or square cross-section. In addition, the rod can be flattened or oval in cross-section to provide additional resting area when formed in to the hook portion 52. To form the disclosed hook portion 52, a suitable length of polycarbonate rod is heated in an industrial oven at about 320-degrees Fahrenheit. The polycarbonate rod must be heated in step fashion for a number of days to insure the quality of the polycarbonate. Once sufficiently heated, the rod is bent into its desired shape using forms and allowed to cool and harden to maintain the desired shape. Of course, other techniques for forming the disclosed hook portion can be used, such as injection molding.

In the present embodiment, the shaft portion 54 is hollow and can be composed of fiberglass, acrylic, polycarbonate, aluminum or other metal, or other strong material. The shaft portion 54 can be any desirable length. However, the shaft portion 54 is preferably about 24-inches to even 50-inches in length for use with large bodied poisonous snakes, such as Gaboon Vipers and the like. The shaft portion 54 can include extensions (not shown) for supporting the snakes at different distances from the handle.

An end (not shown) of the hook portion 52 fits within a distal end 55 of the shaft portion 54 and is attached thereto. Because the snake rod 50 is used to support large bodied snakes, which can weigh up to 200-lbs. or more, the attachment at point 55 is preferably robust. Preferably, an epoxy or glue, to attach the hook portion 52 to the shaft portion 54. However, other techniques known in the art can be used, such as a bolt and nut passing through the ends of the hook and shaft portions 52 and 54 or by crimping the end 55 of the shaft portion 54 on the end of the hook portion 52.

As best shown in FIG. 3B, the hook portion 52 is formed into the recurve from a cylindrical rod of polycarbonate as described above. The rod forming the hook portion 52 is preferably about ¼-inch to 3-inch thick in diameter 56. The jaw opening 58 can be about ½-inch up to and including 12-inches. In addition, the distal end 59 of the hook portion 52 preferably forms a blunt point 59 for initially fitting the hook under a snake when using the snake hook 50.

As discussed in the background section of the present disclosure, snake hooks in the prior art have hook portions made of aluminum, steel, and titanium, and these metal hooks are formed from metal rods having ⅜-inch diameter. Such a thin rod for the hook portion can be undesirable for use with some snakes, such as neonates or the Gaboon Viper due to their ribs. In addition, large bodied snakes weighing as much as 200-lbs. need a hook with a broad base, which the thin rod of the prior art hooks do not provide. As also noted above, the metal hooks in the prior art are also formed from flat metal, which can have a thickness of about 3/16-inch. These flat metal hooks can also be undesirable for use with some snakes, such as neonates or the Gaboon Viper due to their ribs.

In contrast, the rod forming the disclosed hook portion 52 has a diameter of about ¼-inch to 3-inches for the hook portion 52. The larger diameter polycarbonate rod provides a broad base or resting area on the hook portion 52 for supporting large bodied snakes and overcomes the undesired effects of the thinner, metal hooks in the prior art on the anatomy of the snakes. The smaller diameter polycarbonate rod for the hook portion 52 is best suited for smaller neonate snakes to eliminate possible injury that metal can do to the delicate skeletal structure and skin of the newborn snakes. For example, metal hooks known in the art can puncture or crush these animals. Because newborn snakes can still be venomous, use of a hook is still beneficial. When using the disclosed polycarbonate hook portion 52 formed from a smaller diameter rod, a handler can maintain a safe distance, but the flexibility of the rod will insure the snake will not get accidentally injured.

As discussed in the background section of the present disclosure, snake hooks in the prior art for use with large bodied snakes have metal hook portions weighing as much as 12-lbs. These heavy metal hooks in the prior are attached to rods having lengths as long as 24-inches or even 54-inches, for example, which further amplifies their weight to a handler using them. Any addition weight caused by the prior art snake hooks makes handling large bodied snakes more difficult. Furthermore, when handling large bodied snakes and especially poisonous snakes, a handler may use two snake hooks with one in each hand. Thus, the heavy metal hooks in the prior art also make handling a snake with two hooks by a handler more difficult.

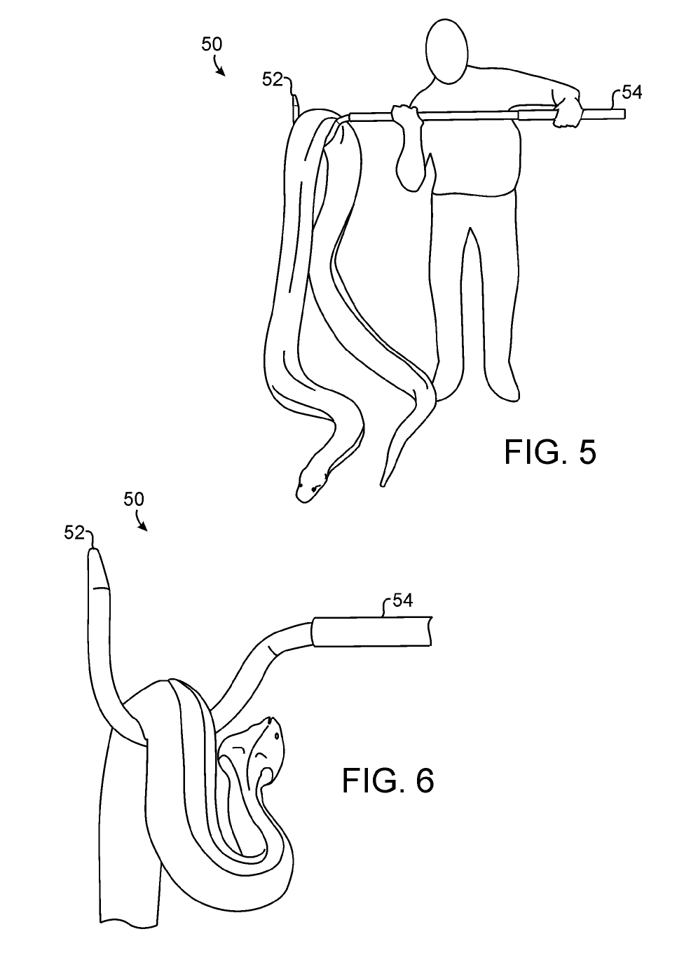

In contrast, the disclosed hook portion 52 composed of polycarbonate is lightweight and can weigh about 2-lbs. or less depending on its size. Such a lightweight for the hook portion 52 does not add substantial weight and allows a handler to easily use one or more of the snake hooks 52. Thus, the polycarbonate hook portion 52 has a minimal weight but is very strong. FIG. 5 shows a handler with the disclosed snake hook 50 moving a large python.

In addition, the disclosed hook portion 52 is beneficial for use with Gaboon Vipers as opposed to the metal hooks with small diameters of the prior art that get between the Viper's ribs and break them. Because of the venomousness of the Gaboon Viper as well as its two-inch fangs, the disclosed hook portion 52 can be especially useful because the disclosed hook portion 52 is lightweight and enables handlers to move the snake at a distance without endangering the snake. Because the resting area is greater on the disclosed hook portion 52, the Viper will be more relaxed and comfortable on the hook.

For example, if a Viper is uncomfortable on a thin, metal hook of the prior art, the snake will attempt to gain a more comfortable position and move itself from the uncomfortable hook and onto the shaft. By contrast, FIG. 6 shows a Gaboon Viper resting on the disclosed hook portion 52 of the snake hook 50. Instead of attempting to gain a more comfortable position on the shaft portion 54, the snake is resting on the thicker hook portion 52 and merely eyeing the handler, who is at a distance and not shown. Furthermore, metal hooks of the prior art can cause snakes to react by attempting to jump off of the hook or to move about on the hook because the metal “feels cold” to the snake. In contrast, the disclosed hook portion 52 composed of the polycarbonate or other plastic material stays at about room temperature and feels more natural for the snake.

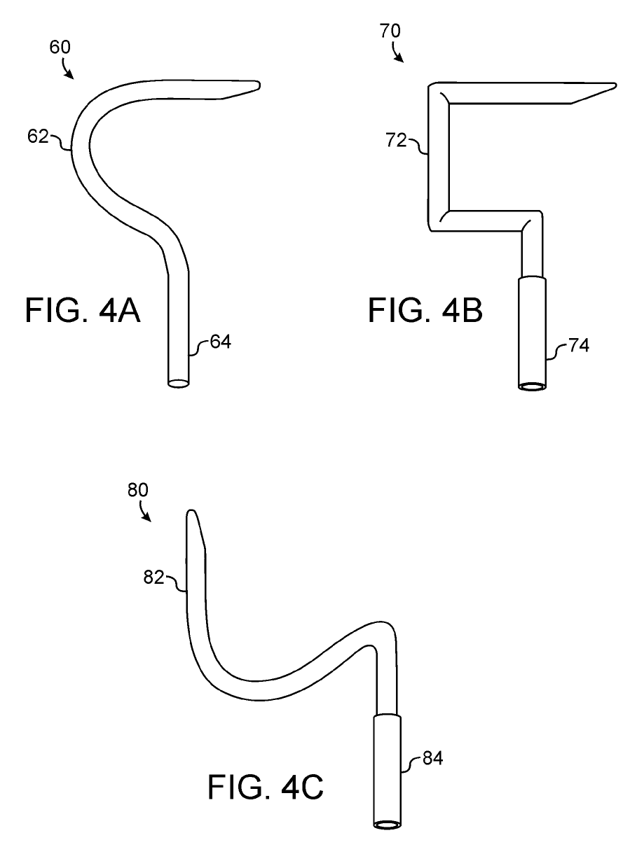

Referring to FIGS. 4A-4B, various embodiments of the disclosed snake hook are illustrated. In FIG. 4A, the snake hook 60 includes a hook portion 62 integrally formed with a shaft portion 64, which is only partially shown. In this embodiment, both the hook and shaft portions 62 and 64 are composed of polycarbonate. This snake hook 60 may be best suited for handling smaller neonates because of flexibility.

In FIG. 4B, the snake hook 70 includes a hook portion 72 attached to a shaft 74, which is only partially shown. The hook portion 72 has an alternative profile than the previous embodiments with the recurve profile. The hook portion 72 has a generally rectilinear profile and is suitable for use in corners of a cage. In FIG. 4C, the snake hook 80 includes a hook portion 82 on a shaft portion 84. The hook portion 82 has an S-profile, which is suitable for extracting snakes from trees or the like.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A device for handling a snake, comprising:
a shaft portion; and
a hook portion attached to the shaft portion, the hook portion being formed from a plastic material and having a profile for supporting the snake.

2. The device of claim 1, wherein an end of the hook portion is inserted into a hollow defined in a distal end of the shaft portion.

3. The device of claim 1, wherein the plastic material is selected from the group consisting of polycarbonate, thermoplastic, High-Density Polyethylene (HDPE), Ultra High Molecular Weight Polyethylene (UHMW-PE), and acetal resin.

4. The device of claim 1, wherein the hook portion is formed from a preformed rod of extruded polycarbonate being heated and bent into the profile for supporting the snake.

5. The device of claim 4, wherein the rod is substantially cylindrical and has a diameter of about 0.25 to 3-inches.

6. The device of claim 4, wherein the shaft portion is formed from the preformed rod of extruded polycarbonate and is integral with the hook portion.

7. The device of claim 1, wherein the hook portion defines a jaw opening of approximately 0.5 to 12-inches.

8. The device of claim 1, wherein the hook portion weighs less than or equal to approximately 2-lbs.

9. The device of claim 1, wherein the profile for supporting the snake defines a recurve, an S-curve, or a rectilinear curve.

10. A device for handling a large bodied snake by a handler, comprising:
a shaft for holding by the handler; and
a hook attached to the shaft, the hook being formed from a rod of extruded polycarbonate, the rod being heated and bent into a profile for supporting the snake.

11. The device of claim 10, wherein an end of the hook is inserted into a hollow defined in a distal end of the shaft.

12. The device of claim 10, wherein the shaft is formed from the rod of extruded polycarbonate and is integral with the hook.

13. The device of claim 10, wherein the rod is substantially cylindrical and has a diameter of about 0.25 to 3-inches.

14. The device of claim 10, wherein the hook defines a jaw opening of approximately 0.5 to 12-inches.

15. The device of claim 10, wherein the hook weighs less than or equal to approximately 2-lbs.

16. The device of claim 10, wherein the profile for supporting the snake defines a recurve, an S-curve, or a rectilinear curve.

17. A device for handling a snake by a handler, comprising:
a shaft for holding by the handler; and
a hook attached to the shaft, the hook formed from a substantially cylindrical, preformed rod of extruded polycarbonate, the rod having a diameter of about 0.5-inches to about 1-inch and being heated and bent into a profile for supporting the snake, the profile defining a jaw opening of about 0.5 to about 3.5-inches, the hook weighing less than or equal to approximately 2-lbs.

18. The device of claim 17, wherein an end of the hook is inserted into a hollow defined in a distal end of the shaft.

19. The device of claim 17, wherein the shaft is formed from the rod of extruded polycarbonate and is integral with the hook.

20. The device of claim 17, wherein the profile for supporting the snake defines a recurve, an S-curve, or a rectilinear curve.
